(19) United States
(12) Patent Application Publication
(10) Pub. No.: US 2009/0304351 A1
(43) Pub. Date: Dec. 10, 2009

(54) SYSTEMS AND METHODS FOR DETERMINING BEHAVIORS FOR LIVE AND PLAYBACK CONSUMPTION

(75) Inventors: Toni Juhani Paila, Koisjarvi (FI); Topi-Oskari Pohjolainen, Helsinki (FI)

Correspondence Address: Nokia, Inc., 6021 Connection Drive, MS 2-5-520, Irving, TX, 75039, US

(73) Assignee: Nokia Corporation, Espoo (FI)

(21) Appl. No.: 12/390,416

(22) Filed: Feb. 21, 2009

Related U.S. Application Data
(60) Provisional application No. 61/030,843, filed on Feb. 22, 2008.

(51) Int. Cl. H04N 5/91

(52) U.S. Cl. 386/95; 386/E05.003

(57) ABSTRACT

Systems and methods for modifying the behavior and use of rich media environment (RME) information depending on the state of consumption of related content. Mechanisms are provided by which RME information can be used in different ways depending upon whether the content at issue is being consumed “live” or whether the content at issue is being played back at a later time after the “live” transmission. An RME scene update and/or scene description can include an optional tag or identification, with associated material being valid for use during one of media playback and live consumption. Particular behavior selection can also be inherent in the scene update and/or scene description script, such that the script determines the behavior of the RME based upon the status of the media consumption. Further still, resources referenced by a script can be fetched before content is rendered, where the resources may be present, absent, or modified depending upon whether the content is being consumed live or during a playback session.

### RELATED APPLICATION

This application claims priority to U.S. Application No. 61/030,843 filed Feb. 22, 2008, which is hereby incorporated by reference in its entirety.

### FIELD OF THE INVENTION

The present invention relates generally to rich media content and services. More particularly, the present invention relates to the updating of rich media information in different environments and use situations.

### BACKGROUND OF THE INVENTION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Over the past few years, mobile device capabilities have been increasing at a rapid pace, resulting in devices which provide, for example, increased processing power, larger screen displays, and improved digital services. As a result, consumer demand for rich multimedia content and applications, such as on-demand services that can be delivered anywhere and anytime, has also increased. As used herein, rich media content generally refers to content that is graphically rich and contains compound/multiple media including graphics, text, video and/or audio. In addition, rich media can dynamically change over time and can respond to user interaction, while being delivered through a single interface.

Various types of rich media environment (RME) technologies may be used to provide information concerning media scenes and layouts, as well as to manage updates to such scenes and layouts. As used herein, RME may include Scalable Vector Graphics (SVG), Flash technology, Moving Pictures Experts Group (MPEG)-Lightweight Application Scene Representation (LASeR) technology, and other technologies.

### SUMMARY OF THE INVENTION

Various embodiments address the above-described use situation and others by providing systems and methods for modifying the behavior and use of RME information depending on the state of consumption of related content. More particularly, various embodiments provide mechanisms by which RME information can be used in different ways depending upon whether the content at issue is being consumed “live” or whether the content at issue is being played back at a later time after the “live” transmission. According to various embodiments, an RME scene update and/or scene description can include an optional tag or identification that is valid during one of media playback or live consumption. In these embodiments, associated RME material is utilized when the value of the tag is consistent with how the content is being consumed, and/or other RME scene information is utilized when the value of the tag is non consistent with how the content is being consumed. Certain embodiments also involve having particular behavior selection inherent in the scene update script and/or scene description script, such that the script determines the behavior of the RME based upon the status of the media consumption. In still further embodiments, resources referenced by a script can be fetched before content is rendered, where the resources may be present, absent, or modified depending upon whether the content is being consumed live or during a playback session.

These and other advantages and features of various embodiments of the present invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is a flowchart showing the processes by which various embodiments are implemented;

FIG. 2 is an overview diagram of a system within which various embodiments of the present invention may be implemented;

FIG. 3 is a perspective view of an electronic device that can be used in conjunction with the implementation of various embodiments of the present invention; and

FIG. 4 is a schematic representation of the circuitry which may be included in the electronic device of FIG. 3.

### DETAILED DESCRIPTION OF VARIOUS EMBODIMENTS

Different types of content, including content comprising RME information, can be consumed by a device in different situations. For example, such content can sometimes be either consumed “live,” i.e., during an initial transmission of a performance, or at a later time based upon a performance which has previously been broadcast or multicast. When the content is consumed at a time after the original broadcast, multicast or transmission, it is referred to herein as “playback consumption.”

The following is an example use situation involving the consumption of content including RME information. In this use situation, a service provider makes live programming available. The live programming may comprise, for example, a television show format that includes live voting at one or more times. This live voting may occur at either predefined times and/or on an ad hoc basis. The programming is made available in a form comprising one or more content streams and a stream delivering RME information. The RME stream describes the layout and updates to the layout. Additionally, the RME stream delivers the “additional” interaction elements, i.e., the live voting information, as well as essential spatial and temporal layout elements which make the consumption experience meaningful. This information is also used to ensure that the interaction elements are provided for consumption in the intended manner. These elements are delivered as full scene descriptions and as scene updates that update at least a portion of the described scene.

In the above situation, it is helpful to envision a situation where one uses scene updates to render the “additional” interaction elements. Additionally, it is also possible that the consuming terminal records the program for later playback, with both the content streams and the RME stream being recorded during this process. During the subsequent playback of the recorded programming, whose “master” layout stream is the RME stream, some of the updates that are delivered in the RME stream will no longer be valid or should be rendered with different content. For example, in the case of live voting, it does not make sense to provide the user with the opportunity to vote, since the voting actually took place when the programming was first provided live, meaning that the window for voting may have already closed. Instead, it may be preferable to simply provide the user with the results of the previous “live” vote.

Various embodiments address the above-described use situation and others by providing systems and methods for modifying the behavior and use of RME information depending on the state of consumption of related content. More particularly, various embodiments provide mechanisms by which RME information can be used in different ways depending upon whether the content at issue is being consumed “live” or whether the content at issue is being played back at a later time after the “live” transmission. According to various embodiments, an RME scene update and/or scene description can include an optional tag or identification that is valid during one of media playback or live consumption. In these embodiments, associated RME material is utilized when the value of the tag is consistent with how the content is being consumed, and/or other RME scene information is utilized when the value of the tag is non consistent with how the content is being consumed. Certain embodiments also involve having particular behavior selection inherent in the scene update script and/or scene description script, such that the script determines the behavior of the RME based upon the status of the media consumption. In still further embodiments, resources referenced by a script can be fetched before content is rendered, where the resources may be present, absent, or modified depending upon whether the content is being consumed live or during a playback session.

In one embodiment, an identification may be used with an RME scene update to indicate whether associated script is valid or not during playback. For example, an RME scene update may include an optional tag or other identifier. If the optional tag or identifier is set to “true” or is otherwise valid, then this would indicate that the consuming device should use the associated script during playback consumption. As an example, a “validWhenRecorded” tag may be included in an RME scene update, with the associated script being valid during playback. Example syntax showing the use of such a tag is as follows:

<script type=″application/ecmascript″

validWhenPlayedBack=”true” > <![CDATA[
function circle_click(evt) {

var circle = evt.target;
var currentRadius = circle.getFloatTrait(″r″);
if (currentRadius == 100)

circle.setFloatTrait(″r″, currentRadius*2);

else

circle.setFloatTrait(″r″, currentRadius*0.5);

}

]]> </script>

In the above example, the script is executed only during a “playback” rendering, i.e., when the rendering the content is not part of a “live” transmission. The script would not be executed during a “live” rendering. Instead, the script immediately following the “else” script would be used for rendering. As an alternative to the above, a tag such as “validWhenLive” could be used, with such associated script being used for rendering when the tag is “true” and is skipped otherwise.

In addition to “script” elements, such a tag may be included in virtually any SVG element. The following is an example demonstrating this point:

<g>

<video id=“main-video” xlink:href=“nano.sdp” />
<image id=“voting-buttons” validWhenPlayedBack=“false” />
<image id=“results” xlink:href=“results.png”
validWhenPlayedBack=“true” />

</g>

Referring to the “live voting” use situation discussed previously, in the event that live consumption is taking place, the voting buttons would be shown on the display, permitting a viewer to vote on the subject matter at issue. However, if playback consumption is occurring, then the script could indicate that the voting buttons are not to be shown. Alternatively, instead of showing the voting buttons, the results of the previous “live” vote could be shown. In still another option, it is possible that the voting buttons are shown, but the results of the “live” vote are exhibited if a user elects to select on of the voting options. In this scenario, the results for the selected option could be highlighted, underlined, have its font or background changed, etc. Other variations of the above could also be implemented as desired.

In an additional embodiment, rather than including a tag or other identifier for use with scene update information or scene description information, the behavior selection can be inherent within the actual scene update script or scene description script. According to this particular embodiment, the script is always executed when it is read, and the script determines the behavior of how the content is to be rendered.

In one particular example of this embodiment, the script can instruct the terminal to obtain the current time, and the behavior is dependent upon the obtained time. In this situation, the obtained current time is compared to a time stamp for the rendered content. The following is example text showing this arrangement:

<script type=“application/ecmascript”> <![CDATA[

function circle_click(evt) {

var time = system.getCurrentTime( );
if (time == 100) // Synchronization provided by RME sender

circle.setFloatTrait(“r”, currentRadius*2); // AAA

else

circle.setFloatTrait(“r”, currentRadius*0.5); // BBB

}

]]> </script>

When consuming the above script, the consuming device will render the underlying content differently depending upon the current time.

In another example scenario, an indication can be provided in the script to indicate whether the content is recorded or live. This is depicted in the following text:

<script type=″application/ecmascript″> <![CDATA[

function circle_click(evt) {

var isRecorded = system.isThisRecordedPlayback( );
if (isRecorded = “false”)

circle.setFloatTrait(″r″, currentRadius*2); // AAA

else

circle.setFloatTrait(″r″, currentRadius*0.5); // BBB

}

]]> </script>

When reading the above text, the terminal only needs to determine whether the “is Recorded” field is “true” or “false” in order to determine which RME information should be rendered during rendering. In the above example, the line tagged with “AAA” is executed in the live case, while the line tagged with “BBB” is executed in the playback/non-real-time case. Alternatively, instead of having an “is Recorded” flag, a “is Live” or similar flag may be used such that, if the flag is identified as “true,” then the transmission is treated as being live for consumption purposes.

In yet a further embodiment, the contents and/or scripts of RME scene update information is the same regardless of whether the consumption is live or recorded. However, the content/and or scripts reference one or more particular resources. During rendering, the terminal is directed to this resource to obtain content at the resource. This content may or may not be present, depending upon whether the consumption is occurring on a live performance or during later playback.

In one particular embodiment, RME scene descriptions refer to a resource that is made available only after a “live” presentation has been completed. In this embodiment, the additional and/or complementary content is delivered in a later RME scene description, in a scene update, or in a broadcast/multicast stream, wherein the scene description or update includes a reference to such content.

The following text describes a particular RME scene update procedure of the type described above:

<script type=″application/ecmascript″> <![CDATA[

function circle_click(evt) {

var resourceX= getURI(“localhost://resourceX”);
if (resourceX == “null”)

circle.setFloatTrait(″r″, currentRadius*2); // AAA

else

resourceX.show( );

}

]]> </script>

In the above example, the consuming terminal must check to determine whether “resourceX” is locally available (this would have been retrieved by the initial script, if it were available). If resourceX is not available (indicated by a null value), then clearly no content is rendered. On the other hand, if there is content available, then the content is rendered.

Alternatively, it is possible for the resource at issue to contain context information. In this case, when the RME/SVG engine accesses the underlying resource, the resource is parsed and its contents are interpreted so that the behavior is rendered differently depending upon whether the consumption is occurring live in playback mode.

As discussed previously, it is possible for a received program including multimedia content to have been previously recorded before it is presented “live” to the consuming terminal for the first time. In various embodiments, this program may be considered to be a “recorded” program. Therefore, in these embodiments, an indication may be provided in order to inform the terminal to render content in a certain manner depending upon whether the program comprises a prerecorded transmission, a live transmission, or a program which was previously transmitted. In this situation, these indications may comprise identifiers including “rendering live,” “rendering server side recorded” and “rendering terminal recorded.” In the “voting” situation discussed previously, a “rendering server side recorded” may result in the viewer still being allowed to vote on the subject matter at issue, while a “rendering server side recorded” may not permit such voting.

Various embodiments discussed herein permit content to be exhibited with many different types of RME information depending upon whether the transmission is live or recorded, and the rendering possibilities extend far beyond the “live voting” example discussed previously. When a terminal renders a recorded program or content, different complementary information may be selected for rendering than was made in the “live” case. For example, certain advertisements may be provided during the “live” transmission, while other advertisements are rendered when a previously recorded transmission is being rendered. Also, when the streamed content is recorded, the complementary information may differ from the complementary information of the “live” program. In these cases, the scene layout may be wholly or partially different, as different scene description and/or scene update information may be used depending upon whether the content is “live,” “server recorded” or “terminal recorded.”

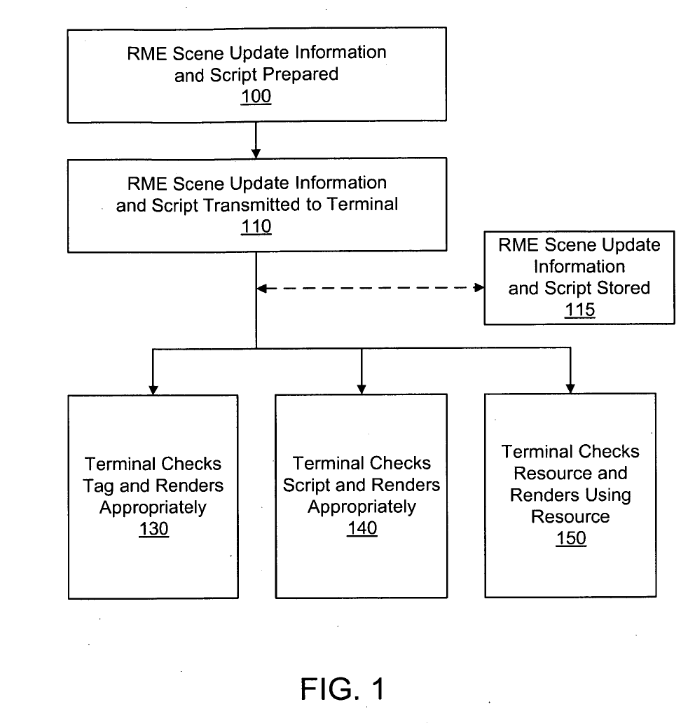

FIG. 1 is a flowchart showing the processes by which various embodiments are implemented. At 100 in FIG. 1, RME scene update information and/or script is prepared for future parsing and use by a rendering device. At 110, the RME scene update information and/or script is transmitted to such a rendering terminal. At 120, the rendering terminal, as part of the rendering process, parses and analyzes the RME scene update information and/or script. It should be noted that, between 110 and 120, it is possible that the RME scene update information and/or script, as well as the related content, has been saved for future playback. Such a saving action is represented at 115.

Depending upon the particular embodiment used, a number of different actions can occur in response to the parsing and analysis of the RME scene update information and script. At 130, the rendering terminal uses at least one tag to determine how to render content depending upon whether the transmission is live or recorded and renders the content in accordance with this indication. At 140, the rendering terminal renders the content based upon information contained within the scene update script, for example by comparing the current time with a time stamp for the associated content. At 150, the rendering terminal checks for a resource referenced by the script and, if the resource is present, renders it appropriately with the associated content.

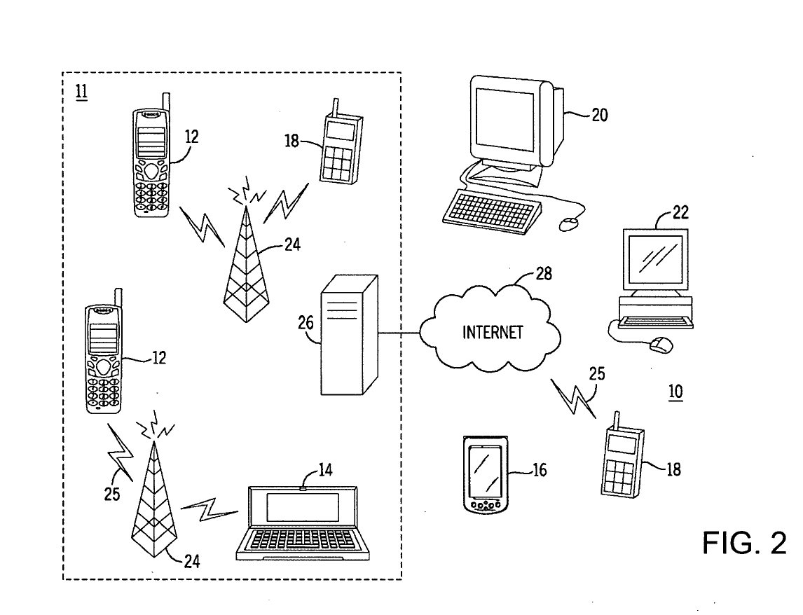

FIG. 2 shows a system 10 in which various embodiments of the present invention can be utilized, comprising multiple communication devices that can communicate through one or more networks. The system 10 may comprise any combination of wired or wireless networks including, but not limited to, a mobile telephone network, a wireless Local Area Network (LAN), a Bluetooth personal area network, an Ethernet LAN, a token ring LAN, a wide area network, the Internet, etc. The system 10 may include both wired and wireless communication devices.

For exemplification, the system 10 shown in FIG. 2 includes a mobile telephone network 11 and the Internet 28. Connectivity to the Internet 28 may include, but is not limited to, long range wireless connections, short range wireless connections, and various wired connections including, but not limited to, telephone lines, cable lines, power lines, and the like.

The exemplary communication devices of the system 10 may include, but are not limited to, an electronic device 12, a combination personal digital assistant (PDA0 and mobile telephone 14, a PDA 16, an integrated messaging device (IMD) 18, a desktop computer 20, a notebook computer 22, etc. The communication devices may be stationary or mobile as when carried by an individual who is moving. The communication devices may also be located in a mode of transportation including, but not limited to, an automobile, a truck, a taxi, a bus, a train, a boat, an airplane, a bicycle, a motorcycle, etc. Some or all of the communication devices may send and receive calls and messages and communicate with service providers through a wireless connection 25 to a base station 24. The base station 24 may be connected to a network server 26 that allows communication between the mobile telephone network 11 and the Internet 28. The system 10 may include additional communication devices and communication devices of different types.

The communication devices may communicate using various transmission technologies including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc. A communication device involved in implementing various embodiments of the present invention may communicate using various media including, but not limited to, radio, infrared, laser, cable connection, and the like.

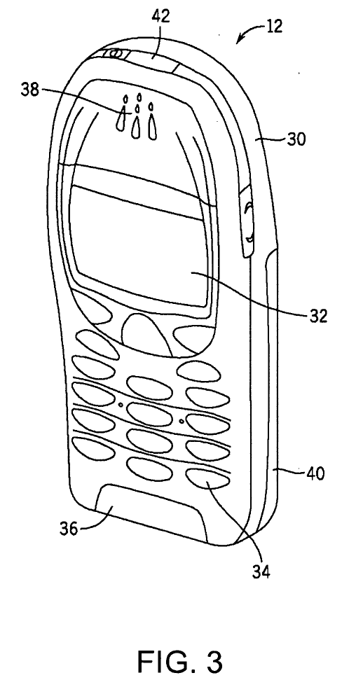

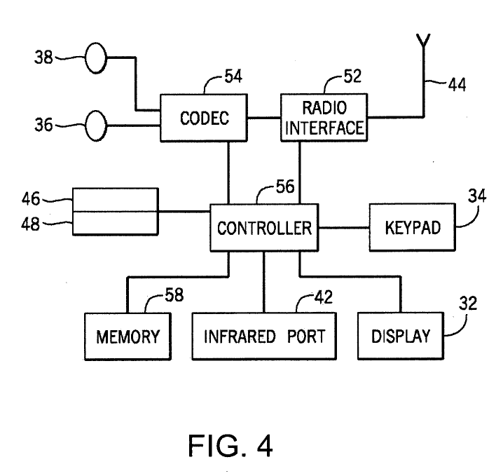

FIGS. 3 and 4 show one representative electronic device 12 within which the present invention may be implemented. It should be understood, however, that the present invention is not intended to be limited to one particular type of device. The electronic device 12 of FIGS. 3 and 4 includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment, a card reader 48, radio interface circuitry 52, codec circuitry 54, a controller 56 and a memory 58. Individual circuits and elements are all of a type well known in the art, for example in the Nokia range of mobile telephones.

The various embodiments described herein are described in the general context of method steps or processes, which may be implemented in one embodiment by a computer program product, embodied in a computer-readable medium, including computer-executable instructions, such as program code, executed by computers in networked environments. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

The various embodiments described herein are described in the general context of method steps or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

Embodiments of the present invention may be implemented in software, hardware, application logic or a combination of software, hardware and application logic. The software, application logic and/or hardware may reside, for example, on a chipset, a mobile device, a desktop, a laptop or a server. Software and web implementations of various embodiments can be accomplished with standard programming techniques with rule-based logic and other logic to accomplish various database searching steps or processes, correlation steps or processes, comparison steps or processes and decision steps or processes. Various embodiments may also be fully or partially implemented within network elements or modules. It should be noted that the words “component” and “module,” as used herein and in the following claims, is intended to encompass implementations using one or more lines of software code, and/or hardware implementations, and/or equipment for receiving manual inputs.

The foregoing description of embodiments has been presented for purposes of illustration and description. The foregoing description is not intended to be exhaustive or to limit embodiments of the present invention to the precise form disclosed, and modifications and variations are possible in light of the above teachings or may be acquired from practice of various embodiments. The embodiments discussed herein were chosen and described in order to explain the principles and the nature of various embodiments and its practical application to enable one skilled in the art to utilize the present invention in various embodiments and with various modifications as are suited to the particular use contemplated. The features of the embodiments described herein may be combined in all possible combinations of methods, apparatus, modules, systems, and computer program products.

What is claimed is:

1. A method, comprising:
receiving rich media environment information, the rich media environment information associated with content to be rendered on a terminal; and
selectively rendering at least a portion of the rich media environment information with the content based upon whether the content is being rendered from a recording of a previous transmission.

2. A computer program product, embodied in a computer-readable storage medium, comprising computer code configured to perform the processes of claim 1.

3. An apparatus, comprising:
a processor configured to:
receive rich media environment information, the rich media environment information associated with content to be rendered on a terminal; and
selectively render at least a portion of the rich media environment information with the content based upon whether the content is being rendered from a recording of a previous transmission.

4. The apparatus of claim 3, wherein the rich media environment information comprises a tag within at least one of scene description information and scene update information, and wherein script associated with the tag is selectively executed based upon whether the content is being rendered from a recording of a previous transmission.

5. The apparatus of claim 3, wherein the rich media environment information comprises an indication within at least one of scene description script and scene update script, and wherein a script portion associated with the indication is selectively executed based upon whether the content is being rendered from a recording of a previous transmission.

6. The apparatus of claim 5, wherein the indication comprises an instruction to obtain a current time, and wherein the current time is compared to a timestamp in order to determine whether the content is being consumed from a live transmission.

7. The apparatus of claim 3, wherein the rich media environment information comprises a reference to a resource, and wherein information contained within the resource is processed for rendering.

8. The apparatus of claim 7, wherein the resource comprises no information if the content is being consumed from a live transmission.

9. The apparatus of claim 7, wherein the resource comprises context information.

10. The apparatus of claim 3, wherein the rich media environment information is rendered differently depending upon whether the content is being rendered from a recorded transmission of previously recorded content, rendered from a live transmission of live content, or rendered from a live transmission of previously recorded content.

11. A method, comprising:
preparing rich media environment information, the rich media environment information associated with content to be rendered on a terminal; and
transmitting the rich media environment information to the terminal for rendering,
wherein the rich media environment information comprises information usable by the terminal to selectively render at least a portion of the rich media environment information depending upon whether the content is being rendered from a recording of a previous transmission.

12. A computer program product, embodied in a computer-readable storage medium, comprising computer code configured to perform the processes of claim 11.

13. An apparatus, comprising:
a processor configured to:
prepare rich media environment information, the rich media environment information associated with content to be rendered on a terminal; and
transmit the rich media environment information to the terminal for rendering,
wherein the rich media environment information comprises information usable by the terminal to selectively render at least a portion of the rich media environment information depending upon whether the content is being rendered from a recording of a previous transmission.

14. The apparatus of claim 13, wherein the information comprises a tag within at least one of scene description information and scene update information, and wherein script associated with the tag is selectively executed based upon whether the content is being rendered from a recording of a previous transmission.

15. The apparatus of claim 13, wherein the information comprises an indication within at least one of scene description script and scene update script, and wherein a script portion associated with the indication is selectively executed based upon whether the content is being rendered from a recording of a previous transmission.

16. The apparatus of claim 15, wherein the indication comprises an instruction to obtain a current time, and wherein the current time is compared to a timestamp in order to determine whether the content is being consumed from a live transmission.

17. The apparatus of claim 13, wherein the information comprises a reference to a resource, and wherein additional information contained within the resource is processed for rendering.

18. The apparatus of claim 17, wherein the resource comprises no additional information if the content is being consumed by the terminal from a live transmission.

19. The apparatus of claim 17, wherein the resource comprises context information.

20. The apparatus of claim 13, wherein the information is usable by the terminal to render the rich media environment information differently depending upon whether the content is being rendered from a recorded transmission of previously recorded content, rendered from a live transmission of live content, or rendered from a live transmission of previously recorded content.

21. A system, comprising:
a server configured to prepare rich media environment information, the rich media environment information associated with content to be rendered; and
a terminal configured to receive the rich media environment information from the server and selectively render the rich media environment information with the content, the selective rendering of the rich media environment information based upon whether the content is being rendered from a recording of a previous transmission.
